(19) United States
(12) Patent Application Publication
(10) Pub. No.: US 2024/0124148 A1
(43) Pub. Date: Apr. 18, 2024

(54) AIRCRAFT ENGINE NACELLE PROVIDED WITH A THRUST REVERSER HAVING A MOBILE EJECTION STRUCTURE

(71) Applicant: Airbus Operations (S.A.S.), Toulouse (FR)

(72) Inventors: Frédéric Chelin, Toulouse (FR); Christophe Bourdeau, Toulouse (FR); Alexandre Bellanger, Toulouse (FR); Lauren Davis, Toulouse (FR)

(21) Appl. No.: 18/333,897

(22) Filed: Jun. 13, 2023

(30) Foreign Application Priority Data
Jun. 14, 2022 (FR) 2205762

(51) Int. Cl. B64D 29/06; F02K 1/76

(52) U.S. Cl. CPC B64D 29/06; F02K 1/763; B64D 2033/0206

(57) ABSTRACT

A nacelle includes a thrust reverser having a cowl movable in translation and an ejection structure also movable in translation and forming with the cowl a moving assembly, the moving assembly configured to moved, alternately, into a closed position in which the ejection structure is inserted into a housing formed in the nacelle and the cowl closes an ejection opening in the nacelle, and an open position in which the cowl releases the ejection opening in the nacelle and the ejection structure is located in this ejection opening, the positioning of the ejection structure in the housing in the closed position making it possible, in particular, to make space in the ejection opening and to reduce the size of the thrust reverser.

### TECHNICAL FIELD

The disclosure herein relates to an aircraft engine nacelle which is provided with a thrust reverser having a mobile ejection structure.

### BACKGROUND

It is known that the engines of an aircraft, for example of a transport airplane, are provided with a thrust reverser, the purpose of which is to slow the aircraft during landing, by producing a reverse-thrust force. The thrust reverser is integrated in the nacelle surrounding the engine, for example a bypass turbojet.

In the usual way, the thrust reverser generally comprises a cowl able to move in translation, alternately, between an open position (deployed position) in which it opens a passageway (or ejection opening) in the nacelle and uncovers flow-deflecting and ejection cascades, and a closed position in which it closes this passageway.

When the thrust reverser is deployed and the cowl is moved into its deployed position, doors close off the path for air from the engine so as to deflect part of the flow toward the ejection cascades and thereafter the outside of the nacelle through the ejection cascades, thereby generating a reverse-thrust aerodynamic force.

The ejection cascades are generally formed of cascades of vanes comprising a large number of deflectors and are rigidly connected to the nacelle, and they therefore have quite a considerable size.

It is an objective of the disclosure herein to reduce the size of this type of thrust reverser.

### SUMMARY

The disclosure herein relates to an aircraft engine nacelle making it possible to achieve this objective, the nacelle comprising at least one thrust reverser having an ejection structure and a cowl movable in translation.

According to the disclosure herein, the ejection structure is also movable in translation and is rigidly connected to the cowl in such a way as to form with the latter a moving assembly, the moving assembly being configured to be able to be moved, alternately, into at least one or other of the following two positions:
a closed position, in which the ejection structure is inserted, at least partially, into a housing formed in the nacelle, and in which the cowl closes an ejection opening in the nacelle; and
an open position, in which the cowl releases the ejection opening in the nacelle and the ejection structure is located in the ejection opening.

Thus, by virtue of the disclosure herein, in the closed position, the ejection structure is moved into a housing of the nacelle. It is therefore not positioned at the passageway (or ejection opening) in the closed position. This makes it possible to free space in the ejection opening and thus reduces the size of the thrust reverser.

Advantageously, the housing is formed in a fan casing of the nacelle.

In addition, advantageously, the cowl comprises at least one box section provided with a front frame. Preferably, this front frame is in one piece.

In a preferred embodiment, the thrust reverser comprises a plurality of doors configured to be able to deploy inside a flow duct in order to divert the flow to the ejection structure in the open position, and the doors are articulated on the front frame of the box section. Advantageously, at least some of the doors are provided with at least one acoustic attenuation panel.

In addition, in a particular embodiment, at least one internal wall of the box section is provided with at least one acoustic attenuation panel.

Furthermore, in a preferred embodiment, the ejection structure comprises at least two mobile carriages, and each of the mobile carriages is mounted sliding in rails.

Moreover, advantageously, each of the mobile carriages comprises deflectors which are joined together with the aid of two end beams, and each of the end beams is configured to be able to slide in one of the rails.

In addition, advantageously, the cowl is formed of at least two cowl parts, and each of the cowl parts is mounted sliding in the rails (used by the mobile carriages).

Furthermore, the ejection structure advantageously comprises a plurality of deflectors.

In a first embodiment, at least some of the deflectors comprise a deflector plate having a concave face, called the upstream face, and a convex face, called the downstream face, and the upstream face and the downstream face of each deflector plate have different curved profiles.

In addition, in a second embodiment, at least some of the deflectors comprise a deflector plate having a concave face, called the upstream face, and a convex face, called the downstream face, and also an end called the inlet end and an end called the outlet end, and each of the deflectors is provided with a spoiler which is integral with the outlet end of the deflector plate and which is arranged transversely with respect to the deflector plate.

Moreover, advantageously, at least some of the deflectors of the ejection structure have at least one of the following features:
at least two of the deflectors are radially offset with respect to one another;
at least some of the deflectors are arranged to create ejection paths, of which at least some have variable widths; and
at least some of the deflectors have features that are variable depending on their location in the ejection structure.

### BRIEF DESCRIPTION OF THE DRAWINGS

The attached figures will make it easy to understand how the disclosure herein can be realized. In these figures, identical references designate elements that are similar.

FIG. 1 is a schematic view, in longitudinal section, of an aircraft engine nacelle provided with a thrust reverser having a mobile ejection structure, in an open (or deployed) position.

FIG. 2 is a schematic view, in longitudinal section, of a nacelle part, showing in particular a thrust reverser, in a closed position.

FIG. 3 is a schematic view, in longitudinal section, of a thrust reverser in an open position.

FIG. 4 is a partial perspective view of a nacelle, showing part of a particular embodiment of an ejection structure.

FIG. 5 is a view similar to that of FIG. 2, the nacelle being provided with acoustic treatment panels.

FIG. 6A is a schematic view, in longitudinal section, of a nacelle part in a closed position.

FIG. 6B is a view similar to that of FIG. 6A, in an intermediate position of opening.

FIG. 6C is a view similar to those of FIGS. 6A and 6B, in an open position.

FIG. 7 illustrates schematically a first embodiment of a deflector of an ejection structure.

FIG. 8 illustrates schematically a second embodiment of a deflector of an ejection structure.

### DETAILED DESCRIPTION

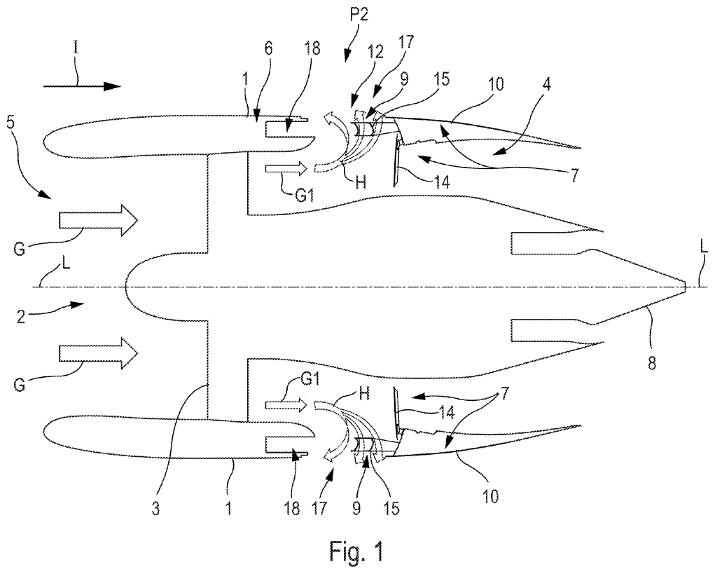

The nacelle 1 shown schematically in a particular embodiment in FIG. 1 and serving to illustrate the disclosure herein is a nacelle of an engine 2, for example of a bypass turbojet engine, of an aircraft (not shown).

In the usual way, a bypass turbojet engine is able, by a fan 3, to generate a flow of hot air coming from the combustion chamber of the turbojet engine and a flow of cold air which circulates around the outside of the turbojet engine through an annular duct 4 formed between a cowling of the turbojet engine and an internal wall of the nacelle 1. The two air flows are ejected from the turbojet engine via the rear of the nacelle 1.

In the example of FIG. 1, the engine 2, in this instance a bypass turbojet engine, is surrounded in the usual way by the nacelle 1. The nacelle 1 has a tubular structure of longitudinal axis L-L, comprising in succession, in the direction of an arrow I (from front to rear) in FIG. 1, an air inlet 5 through which an air flow enters as illustrated by arrows G, a section 6 intended to surround the fan 3 of the turbojet engine, and a section accommodating a thrust reverser 7 and intended to surround the combustion chamber of the turbojet engine, and it ends in a jet pipe ejection nozzle 8.

In the present description:
the term “longitudinal” applies to a direction parallel to the longitudinal axis L-L;
the term “radial” applies to a direction orthogonal to the longitudinal axis L-L;
the term “rear” is defined in the direction indicated by the arrow I, according to the air flow G in the nacelle 1; and
the term “front” is defined in the direction counter to that indicated by the arrow I, hence in the direction counter to the air flow G in the nacelle 1.

The thrust reverser 7 of the nacelle 1 comprises an ejection (and flow diversion) structure 9, of which part is shown in a particular embodiment in FIG. 4.

When the aircraft equipped with the nacelle 1 and with the engine 2 is coming into land, the thrust reverser 7 has the purpose of improving the braking capacity by redirecting forward (in the opposite direction to that of the arrow I) at least some of the thrust generated by the engine 2.

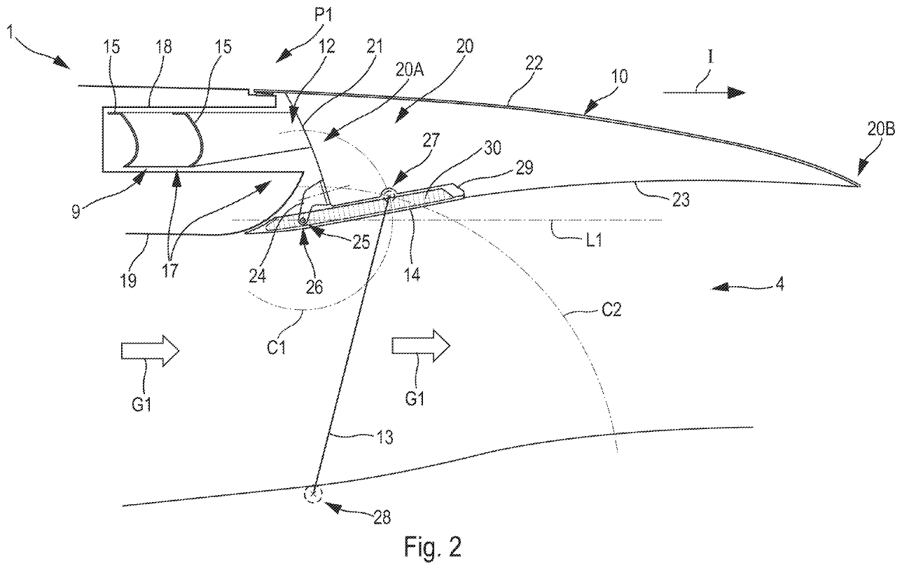

To do this, the nacelle 1 comprises a cowl 10 which is able to move, for example to slide. This cowl 10 is movable in translation parallel to the direction of the longitudinal axis L-L, specifically in the direction illustrated by the arrow I and also in the opposite direction, and it is configured in such a way that, by moving back (in the direction of the arrow I), during a phase of opening, it uncovers an opening called the ejection opening 12. During the movement of the movable cowl 10, doors 14 (or blocking panels), each associated with a mechanical connection 13 (FIG. 2), deploy inside the duct 4 in order to block a flow G1 (corresponding to that part of the flow G circulating in the duct 4) from leaving at the rear as a direct flow. The flow is thus diverted and ejected through the ejection structure 9 situated in the ejection opening 12, as is illustrated by the arrows H in FIG. 1, thus creating the reverse thrust.

FIG. 4 shows, by way of example, part of a particular embodiment of an ejection structure 9. This ejection structure 9 comprises a plurality of deflectors 15 and 16, namely:
orbital deflectors 15, i.e. deflectors which are arranged in a direction (illustrated by an arrow Y) normal to that (illustrated by an arrow X) of the engine axis (longitudinal axis L-L) of the engine 2 and which have the usual function of deflecting the air flow in order to generate the reverse thrust; and
lateral deflectors 16, i.e. deflectors which are arranged in the direction of the engine axis illustrated by the arrow X and which act on the flow leaving the thrust reverser 7, in particular to prevent it from reaching certain zones.

The ejection structure 9 is also movable in translation, like the cowl 10. Moreover, the ejection structure 9 is rigidly connected to the cowl 10 in such a way as to form with the latter a mobile assembly 17. To do this, the ejection structure 9 is fixed to the cowl 10. Any type of customary fixing structure(s), for example a weld, screws or rivets, can be used for this purpose.

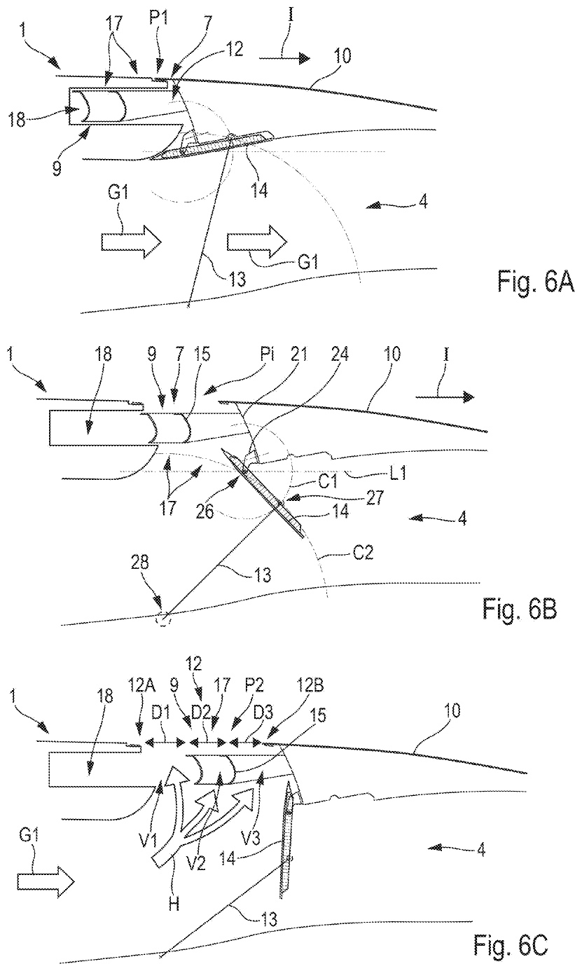

This mobile assembly 17, which is movable in translation along a direction parallel to the longitudinal axis L-L, is configured to be able to be moved, alternately, at least into one or other of the following two (stable) positions:
a closed position P1, shown in FIGS. 2 and 6A in particular, in which the ejection structure 9 is inserted, at least partially, into a housing 18 formed in the nacelle 1, as specified below. In this closed position, the cowl 10 closes the ejection opening 12 in the nacelle 1; and
an open (or deployed) position P2, shown in FIGS. 1, 3 and 6C, in which the cowl 10 releases the ejection opening 12 (that is to say is no longer situated longitudinally at the ejection opening 12), and the ejection structure 9 for its part is located in this ejection opening 12.

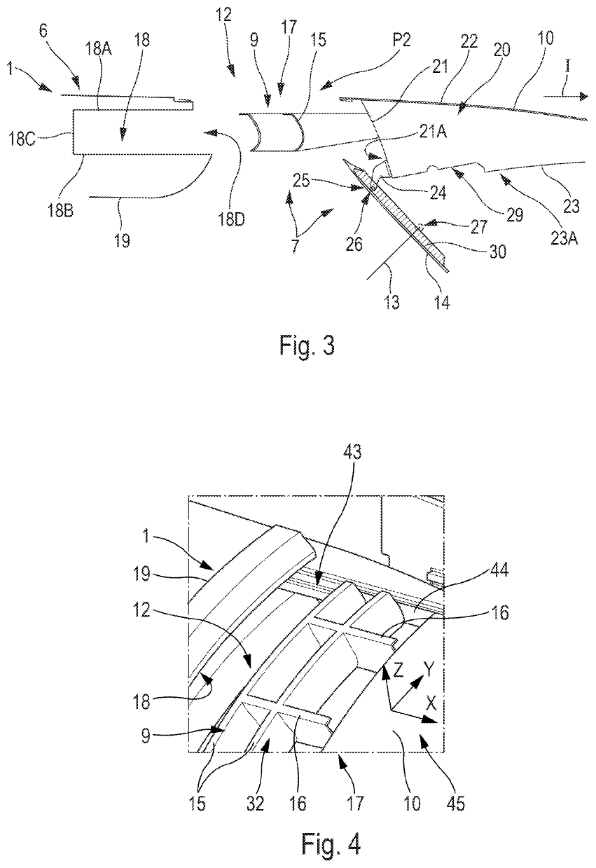

The housing 18 intended to receive the ejection structure 9 (at least partially) in the closed position P1 is formed by a casing 19 of the fan 3 of the nacelle 1, at the level of the section 6, as is shown in FIG. 3. The housing 18 corresponds to a space which is created in the casing 19 and which is preferably delimited by two longitudinal walls 18A and 18B and a radial wall 18C.

The housing 18 has, for example, an annular shape, of which the longitudinal walls 18A and 18B are spaced apart by a radial distance adapted to the radial length of the ejection structure 9, so as to be able to receive the ejection structure 9.

The housing 18 has an opening 18D (FIG. 3) toward the rear, through which the ejection structure 9 enters or leaves the housing 18.

In a preferred embodiment, the housing 18 is configured to receive the whole ejection structure 9 in the closed position P1, as is shown in FIGS. 2, 5 and 6A.

This preferred embodiment permits a maximum reduction in the size of the ejection structure 9. This preferred embodiment is particularly adapted to ejection structures 9 of reduced length. In particular, this preferred embodiment is adapted to an embodiment, specified below, of an ejection structure 9 comprising a reduced number of orbital deflectors 15, for example 1 to 6 orbital deflectors 15, such an ejection structure 9 making it possible to replace a conventional ejection cascade (longer and comprising a large number of orbital deflectors).

In another embodiment (not shown), the housing is configured to receive only a longitudinal part of the ejection structure in the closed position. This embodiment is particularly adapted to a nacelle in which the available space is reduced at the level of the casing 19 of the fan 3 and/or of which the ejection structure is relatively long.

In a preferred embodiment, the cowl 10 comprises at least one box section (FIG. 2), preferably a plurality of box sections. Each of these box sections 20 is provided, at a front end 20A, with a front frame 21.

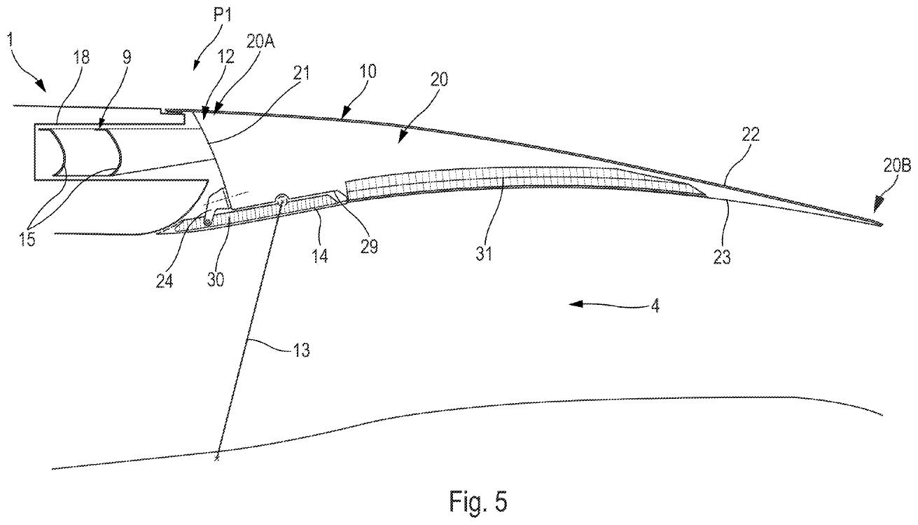

Each front frame 21 is joined, as shown in FIG. 2, to a radially outer wall 22 and to a radially inner wall 23 of the cowl 10, at the front ends of these walls 22 and 23. In a particular embodiment shown in FIGS. 2 and 5, the walls 22 and 23 join at a rear end 20B of the box section 20.

This front frame 21 makes it possible to rigidify the whole of the walls 22 and 23 and therefore the box section 20. This makes it possible in particular to reduce or omit stiffeners, which are usually arranged in the cowl 10, generally inside the wall 22, and are necessary for obtaining the desired rigidity. It is thereby possible to better control the chain of dimensions and the play appearing at the front of the door 14 which generates aerodynamic losses. Moreover, omission of the stiffeners makes it possible to provide deflectors 15, 16 of greater height, which makes it possible to increase their efficacy.

The nacelle 1 as described above, provided with a housing 18 for receiving the ejection structure 9, also makes space, in particular as specified below, for arranging acoustic attenuation panels at places which did not have them, thus creating new acoustic treatment zones or, if appropriate, for arranging larger and/or thicker acoustic attenuation panels.

In a preferred embodiment, the front frame 21 is made in one piece, which facilitates its production and placement and increases its mechanical strength in relation to a cowl made in several parts.

Furthermore, in a preferred embodiment, the thrust reverser 7 comprises a plurality of doors 14, for example four or five doors 14. Each of these doors 14 is configured to deploy inside the flow duct 4 in order to divert the flow toward the ejection structure 9 in the open position P2 (FIGS. 1, 3 and 6C).

As is shown in particular in FIG. 3, in a particular embodiment each of the doors 14 is articulated on the front frame 21 of the box section 20, or one of the box sections 20, of the cowl 10.

In the embodiment in FIG. 3, the door 14 is connected to the front face 21A of the front frame 21 via a bent component 24. The component 24 is fixed, for example welded, screwed or riveted, onto the front face 21A. Moreover, at its free end 25, it is joined to an articulation 26. This articulation 26, for example a support provided with a shaft passing through an orifice at the free end 25 of the component 24, is arranged on the radially outer surface of the door 14. Moreover, it is positioned in proximity to the front end of the door 14, as is shown in FIG. 3.

In addition, the mechanical connection 13 is articulated on the one hand via an articulation 27 to the door 14, toward the rear of the latter, and on the other hand via an articulation 28 (FIG. 2) to a fixed point of the engine 2.

As is illustrated in FIG. 6B, when the cowl 10 slides from the closed position P1 in FIGS. 2 and 6A rearward in the direction of the arrow I, the articulation 26 rigidly connected to the cowl 10, via the front frame 21 and the component 24, moves along a longitudinal line L1 (parallel to the longitudinal axis L-L (FIG. 1)).

During this longitudinal movement, the articulation 27, for its part, turns simultaneously:
along an arc of a circle C1 having, as its center, the articulation 26; and
along an arc of a circle C2 having, as its center, the articulation 28.

This double articulation of the door 14 (about the articulations 26 and 27) generates the movement of the door 14 in the duct 4 during the movement of the cowl 10 toward the rear.

Furthermore, in a particular embodiment as shown in FIG. 3, the inner wall 23 comprises, in its radially inner face 23A, and for each door 14, a housing 29 intended to receive the door 14 in the closed position P1 (FIG. 2). In the example illustrated in FIG. 3, the housing 29 has a shape complementing the shape of the door.

In a particular embodiment, some of the doors 14, preferably all of the doors 14, are provided with at least one acoustic attenuation panel 30, as shown in FIGS. 2 and 3 in particular. In this particular embodiment, the acoustic attenuation panel 30 is integrated in the structure of the door 14. It can also be fixed to the radially outer face of the door.

In addition, in a particular embodiment shown in FIG. 5, the inner wall 23 of the box section 20 is provided, inside the box section 20, with at least one acoustic attenuation panel 31.

The acoustic attenuation panel(s) 30 and 31 can be of any conventional type capable of treating noises in order to attenuate them, for example of the SDOF (Single Degree Of Freedom) type with a single resonant cavity or of the DDOF type (Double Degree Of Freedom) with two resonant cavities.

Furthermore, in a preferred embodiment, the ejection structure 9 is formed of a plurality of mobile carriages 32, preferably two mobile carriages. Each of these mobile carriages 32 is mounted sliding in rails 43, as is shown in FIG. 4.

In the embodiment in FIG. 4, the orbital deflectors 15 of each of the mobile carriages 32 are joined together with the aid of two end beams 44, only one of which can be seen in FIG. 4. Each of these end beams 44 is configured to be able to slide in one of the rails 43.

In addition, the cowl 10 is formed of a plurality of structural parts 45, preferably two parts 45. Each of these parts 45 is mounted sliding in rails, preferably in the rails 43 that are also used by the mobile carriages 32.

The mode of operation of the thrust reverser 7 of the nacelle 1 as described above is described below with reference to FIGS. 6A, 6B and 6C.

During normal operation of the engine 2, the thrust reverser 7 and the mobile assembly 17 are placed in the closed position P1 shown in FIG. 6A. In this closed position P1, the ejection structure 9 is inserted into the housing 18, and the cowl 10 closes the ejection opening 12 in the nacelle 1. The flow G1 (corresponding to that part of the flow G which circulates in the duct 4) is thus ejected in direct flow via the rear of the nacelle 1, as is shown in FIG. 6A, without generation of reverse thrust.

When one wishes to generate reverse thrust, the translation of the mobile assembly 17 from the closed position P1 toward the rear in the direction of the arrow I is controlled in the usual way. The cowl 10 and the ejection structure 9 are thus displaced rearward, and the doors 14 deploy, as is shown in FIG. 6B, which illustrates an intermediate position of opening Pi.

At the end of the translation, the thrust reverser 7 and the mobile assembly 17 are brought to the open (or deployed) position P2 shown in FIG. 6C. In this open position P2, the cowl 10 releases the ejection opening 12, and the ejection structure 9 is situated inside this ejection opening 12. Moreover, the doors 14 are positioned in the duct 4 in order to block the flow G1 from leaving at the rear as a direct flow. Part of the flow G1 is thus diverted toward the ejection structure 9 and is ejected through this ejection structure 9, as illustrated by the arrow H in FIG. 6C, thereby creating the reverse thrust.

Thus, in the closed position P1, the ejection structure 9 is brought into the housing 18 of the nacelle 1. It is therefore not positioned at the ejection opening 12, which makes it possible to free space at the ejection opening 12 and to reduce the size of the thrust reverser 7 and its mass. The space saved can in particular be used for arranging various pieces of equipment or systems, in particular one or more acoustic attenuation panels 31.

In a preferred embodiment comprising special orbital deflectors 15A, 15B as described below, the number of orbital deflectors 15 of the ejection structure 9, for example between 1 and 6 orbital deflectors 15, is greatly reduced by comparison with the usual number of orbital deflectors in a usual cascade-type thrust reverser with ejection vanes, which makes it possible in particular to reduce the size and mass of the ejection structure 9 and to provide a housing 18 of reduced size for accommodating the ejection structure 9.

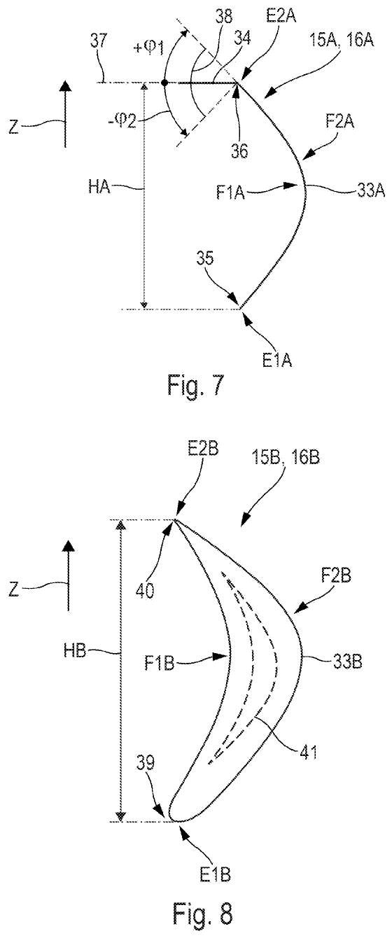

In this preferred embodiment with a reduced number of orbital deflectors 15, for example with two orbital deflectors as in the example of FIGS. 2 to 6C, at least one or more of the orbital deflectors 15 can correspond to the deflector shown schematically in a first embodiment 15A in FIG. 7 or to the deflector shown schematically in a second embodiment 15B in FIG. 8.

More generally, the deflector schematically depicted in the first embodiment 15A, 16A in FIG. 7 and in the second embodiment 15B, 16B in FIG. 8 may correspond to an orbital deflector 15 or to a lateral deflector 16 of the ejection structure.

Whatever the embodiment considered, as is shown in FIGS. 7 and 8 the deflector 15A, 16A or 15B, 16B comprises a deflector plate 33A, 33B. The deflector plate 33A, 33B has a face, called the upstream face F1A, F1B, which is concave, and a face called the downstream face F2A, F2B, which is convex. The upstream face F1A, F1B is situated upstream and the downstream face F2A, F2B is situated downstream with respect to the direction of flow of the flow G1. The deflector plate 33A, 33B also has end called the inlet end E1A, E1B through which the flow H arrives at the deflector plate 33A, 33B, and an end called the outlet end E2A, E2B, at which the flow H leaves the deflector and exits the ejection structure 9.

In the first embodiment shown in FIG. 7, the deflector 15A, 16A is provided with a spoiler 34. The spoiler 34 corresponds to a plate which, for example, is placed substantially orthogonally to a direction called the vertical direction (corresponding to the direction Z of FIG. 4, orthogonal to the directions X and Y) passing through the point 35 (of the inlet end E1A) farthest upstream and the point 36 (of the outlet end E2A) farthest upstream of the deflector plate 33A.

More generally, the spoiler 34 of the deflector 15A, 16A corresponds to a plate arranged in such a way as to present, with respect to a direction 37 (corresponding to the direction X or the direction Y of FIG. 4) orthogonal to the vertical direction Z, an angle within a field of values (of angles) 38. This field of values 38 is defined between values +φ1 and −φ2 (“+” being defined in the direction of the arrow Z, and “−” being defined in the direction opposite to that of the arrow Z) with respect to the direction 37. φ1 and φ2 are angle values, which are equal in the example of FIG. 7. They may also be different. φ1 and φ2 are non-zero angle values, less than or equal to 60° and preferably less than or equal to 45°.

Moreover, the spoiler 34 preferably has a width which is less than or equal to half the height HA of the deflector plate 33A. The height HA corresponds to the length along the vertical direction Z of the deflector plate 33A.

In the example shown in FIG. 7, the deflector plate 33A has a constant thickness. In a variant (not shown) of this first embodiment, the deflector plate 33A can have a variable thickness, as in the second embodiment 15B, 16B shown in FIG. 8.

In this second embodiment 15B, 16B of FIG. 8, the deflector plate 33B of the deflector 15B, 16B has a more or less crescent-shaped overall geometric shape (in cross section), in which the upstream face F1B and the downstream face F2B of the deflector plate 33B have different curved profiles.

Preferably, the maximum thickness of the deflector plate 33B is less than 40% of the height HB of the deflector plate 33B. The height HB corresponds to the length along the vertical direction Z of the deflector plate 33B. Moreover, the directions of the upstream face F1B and of the downstream face F2B, both at the inlet end E1B and at the outlet end E2B, are parameters that can vary. Thus, by adapting these parameters, it is possible to optimize the profile of each of the upstream and downstream faces and thus optimize the overall profile of the deflector 15B, 16B in order to obtain the desired effects on the flow.

In a preferred embodiment, the deflector plate 33B is provided, in its body, with an internal space 41 depicted in dashed line in FIG. 8. This internal space 41 is closed and hollow. In cross section, the internal space 41 may, for example, have a shape (reduced in size) similar to that of the external contour of the deflector plate 33B. This preferred embodiment makes it possible to reduce the mass of the deflector 15B, 16B.

The various characteristics of the orbital deflectors 15 used in the ejection structure 9, particularly the number thereof, the way in which they are embodied, and the size and arrangement thereof, may be dependent on the properties and characteristics envisioned for the ejection structure 9 and therefore for the thrust reverser 7.

In the embodiment shown in FIG. 6C, the ejection structure 9 comprises two orbital deflectors 15. These two orbital deflectors 15 are arranged one behind the other, from upstream to downstream, so as to create ejection paths V1, V2 and V3 in the ejection opening 12. These ejection paths V1, V2 and V3 have longitudinal distances D1, D2 and D3 at the outlet end of the ejection structure 9, namely:
the distance D1 between an upstream end 12A of the ejection opening 12 and the farthest upstream orbital deflector 15;
the distance D2 between the two orbital deflectors; and
the distance D3 between the farthest downstream orbital deflector 15 and a downstream end 12B of the ejection opening 12.

In the example of FIG. 6C, the distances D1, D2 and D3 are different and are selected in such a way as to optimize the ejection of the flow through the ejection paths V1, V2 and V3 and obtain the desired properties for the thrust reverser 7 in particular as regards ejection. In an embodiment variant, it is equally conceivable for some of the distances D1, D2 and D3 or all of the distances D1, D2 and D3 to be equal. Setting the distances D1 to D3 is an important parameter in modifying the performance of the ejection structure 9 and thus of the thrust reverser 7. In particular, as the flow G1 (FIG. 1) arriving at the thrust reverser 7 is not uniform, the separation of the orbital deflectors 15 and therefore the distances D1 to D3 can in particular be adapted in order to optimize the flow H that passes through the ejection structure 9.

Moreover, in the example of FIG. 6C, the two orbital deflectors 15 are aligned radially. In an embodiment variant (not shown), it is equally conceivable that the orbital deflectors of the ejection structure are offset radially with respect to each other. This radial offset makes it possible in particular to contribute to obtaining particular flow characteristics desired for the ejection structure 9.

In addition, in the example of FIG. 6C, the two orbital deflectors 15 are identical. In an embodiment variant (not shown), it is equally conceivable that the orbital deflectors of the ejection structure are different. These differences may, for example, relate to the height of the deflectors and the geometry of the upstream and/or downstream faces of the deflector plates of the orbital deflectors.

As a result, with the preferred embodiment described above, great flexibility is achieved in producing the ejection structure 9. Specifically, it is possible in particular to vary one, several or all of the following parameters of the orbital deflectors 15 and/or the lateral deflectors 16 in order to obtain the desired properties for the ejection structure 9:
their number;
their individual characteristics, including their shape and size;
their location within the ejection structure, that is to say both their longitudinal position (along the axis X) and their radial position (along the axis Z) in the ejection structure, particularly so as to define the characteristics of the ejection paths; and
a variation in their individual characteristics according to their location in the ejection structure.

Any combination of these parameters may be implemented in an engine, depending on the characteristics of the engine on which these orbital deflectors are mounted. The foregoing variable parameters have a significant impact on the performance of the thrust reverser 7 and can therefore be selected in order to produce an ejection structure 9 and a thrust reverser 7 that are suited to the engine and to the nacelle into which they are incorporated in such a way as to obtain the desired properties and performances, and in particular to generate controlled flow over the entire perimeter of the engine, this flow being, for example, tailored to a desired flow map that is dependent in particular on characteristics of the engine and aerodynamic constraints of the aircraft.

The number and shape of the orbital deflectors 15 make it possible to meet criteria regarding flow rate performance (flow rate high enough to avoid problems with the operation of the engine fan) and regarding effectiveness (reverse-thrust force). The obtained increase in effectiveness makes it possible greatly to reduce the travel of the thrust reverser 7 and particularly of the mobile cowl 10, a 40% reduction in opening being conceivable for certain embodiments, something which offers a significant advantage, particularly in terms of the kinematics, the length of the actuators, the chain of dimensions, the mass, etc.

In the context of the disclosure herein, such an ejection structure 9 with a reduced number of orbital deflectors 15 has above all the advantage of being of reduced size, something which allows it to be easily arranged in a housing 18 (of reduced size) in the nacelle 1 in the closed position.

The nacelle 1, as described above, therefore affords many advantages. In particular:
in the closed position P1, the ejection structure 9 is brought into the housing 18 of the nacelle 1, which makes it possible to free space at the ejection opening 12 and to reduce the size of the thrust reverser 7 and its mass;
the production of a rigid box section 20 makes it possible in particular to reduce the number of stiffeners and save mass and space;
the omission of the stiffeners makes it possible in particular to provide deflectors 15, 16 of greater height, which makes it possible to increase their efficacy and more generally that of the ejection structure 9;
the space saved in the nacelle 1 can in particular be used for arranging various pieces of equipment or systems, more particularly one or more acoustic attenuation panels 30, 31, in particular inside the box section 20; and
the rigid nature of the box section 20 makes it possible to control the chain of dimensions and the play appearing at the front of the door 14 which normally generates aerodynamic losses.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for an aircraft engine, the nacelle comprising at least one thrust reverser having an ejection structure and a cowl movable in translation, the ejection structure also being movable in translation and being rigidly connected to the cowl to form with the cowl a moving assembly, the moving assembly being configured to be able to be moved, alternately, into one or another of two positions comprising:
a closed position, in which the ejection structure is inserted, at least partially, into a housing formed in the nacelle, and in which the cowl closes an ejection opening in the nacelle; and
an open position, in which the cowl releases the ejection opening in the nacelle and the ejection structure is located in the ejection opening, wherein the cowl comprises at least one box section comprising a front frame formed in one piece.

2. The nacelle of claim 1, wherein the housing is formed in a fan casing of the nacelle.

3. The nacelle of claim 1, wherein the thrust reverser comprises a plurality of doors configured to deploy inside a flow duct to divert a flow to the ejection structure in the open position, and wherein the doors are articulated on the front frame of the box section.

4. The nacelle of claim 3, wherein at least some of the doors comprise at least one acoustic attenuation panel.

5. The nacelle of claim 1, wherein at least one internal wall of the box section comprises at least one acoustic attenuation panel.

6. The nacelle of claim 1, wherein the ejection structure comprises at least two mobile carriages, and wherein each of the mobile carriages is mounted sliding in rails.

7. The nacelle of claim 6, wherein each of the mobile carriages comprises deflectors joined together with two end beams, and wherein each of the end beams is configured to slide in one of the rails.

8. The nacelle of claim 6, wherein the cowl is formed of at least two cowl parts, and wherein each of the cowl parts is mounted sliding in the rails.

9. The nacelle of claim 1, wherein the ejection structure comprises a plurality of deflectors.

10. The nacelle of claim 9, wherein at least some of the deflectors comprise a deflector plate having a concave face, that is an upstream face, and a convex face, that is a downstream face, and also an end that is an inlet end and an end that is an outlet end, and wherein each of the deflectors comprises a spoiler which is integral with the outlet end of the deflector plate and which is arranged transversely with respect to the deflector plate.

11. The nacelle of claim 9, wherein at least some of the deflectors comprise a deflector plate having a concave face, that is an upstream face, and a convex face, that is a downstream face, and wherein the upstream face and the downstream face of each deflector plate have different curved profiles.

12. The nacelle of claim 9, wherein at least some of the deflectors of the ejection structure have at least one of:
at least two of the deflectors are radially offset with respect to one another;
at least some of the deflectors are arranged to create ejection paths, of which at least some have variable widths; and
at least some of the deflectors have features that vary depending on their location in the ejection structure.
